(19) United States
(12) Patent Application Publication
(10) Pub. No.: US 2020/0194155 A1
(43) Pub. Date: Jun. 18, 2020

(54) SUPERCONDUCTING WIRE AND SUPERCONDUCTING COIL

(71) Applicant: SUMITOMO ELICTRIC INDUSTRIES, LTD., Osaka-shi, Osaka (JP)

(72) Inventors: Genki HONDA, Osaka-shi (JP); Tatsuoki NAGAISHI, Osaka-shi (JP); Masaya KONISHI, Osaka-shi (JP); Kotaro OHKI, Osaka-shi (JP); Takashi YAMAGUCHI, Osaka-shi (JP); Yoshihiro HONDA, Osaka-shi (JP); Tatsuhiko YOSHIHARA, Osaka-shi (JP)

(73) Assignee: Sumitomo Electric Industries, Ltd., Osaka-shi, Osaka (JP)

(21) Appl. No.: 16/614,896

(22) PCT Filed: May 22, 2017
(86) PCT No.: PCT/JP2017/019025

§ 371 Date: Nov. 19, 2019

(51) Int. Cl. H01F 6/06

(52) U.S. Cl. CPC H01F 6/06

(57) ABSTRACT

A superconducting wire has a tape-like shape, and includes a superconducting layer. An amount of heat required to raise temperature from 77 K to 300 K, for a unit region having a length of 1 m and a width of 4 mm in the superconducting wire, is more than or equal to 200 J and less than or equal to 500 J.

### TECHNICAL FIELD

The present invention relates to a superconducting wire and a superconducting coil.

### BACKGROUND ART

Conventionally, a superconducting wire disclosed in Japanese Patent Laying-Open No. 2015-28912 (PTL 1) has been known. The superconducting wire described in PTL 1 includes a substrate, a superconducting layer disposed on a main surface of the substrate with an intermediate layer being interposed therebetween, a protective layer formed on the superconducting layer, a stabilization layer made of copper, and a metal layer formed of a metal softer than copper.

### CITATION LIST

### Patent Literature

PTL 1: Japanese Patent Laying-Open No. 2015-28912

### SUMMARY OF INVENTION

A superconducting wire in accordance with one aspect of the present disclosure has a tape-like shape, and includes a superconducting layer. An amount of heat required to raise temperature from 77 K to 300 K, for a unit region having a length of 1 m and a width of 4 mm in the superconducting wire, is more than or equal to 200 J and less than or equal to 500 J.

### BRIEF DESCRIPTION OF DRAWINGS

FIG. 1 is a schematic cross sectional view of a superconducting wire in accordance with an embodiment.

FIG. 2 is a process chart for illustrating a method for measuring an amount of heat required to raise temperature from 77 K to 300 K for a unit region in the superconducting wire.

FIG. 3 is a schematic view for illustrating the method for measuring the amount of heat required to raise the temperature from 77 K to 300 K for the unit region in the superconducting wire.

FIG. 4 is a schematic cross sectional view of a superconducting coil in accordance with an embodiment in a cross section perpendicular to a coil axis thereof.

### DETAILED DESCRIPTION

### Problem to be Solved by the Present Disclosure

In the superconducting wire disclosed in PTL 1, the metal layer formed of a metal softer than copper is disposed at the outermost periphery. Thus, when the superconducting wire is wound to form a superconducting coil, the metal layers of the adjacent windings of the superconducting wire have a good adhesion therebetween, which can reduce contact resistance between the windings of the superconducting wire. In addition, in PTL 1, if a quench occurs while the superconducting coil is used, a current is passed to the metal layers of the adjacent windings of the superconducting wire to suppress local heat generation, which can protect the superconducting wire.

However, the superconducting wire described above is intended to protect the superconducting wire when a quench occurs, and it is difficult to suppress occurrence of a quench itself.

The superconducting wire and the superconducting coil in accordance with the present disclosure have been made in view of the problem of the conventional technique as described above. More specifically, a superconducting wire and a superconducting coil in which occurrence of a quench can be suppressed are provided.

### Advantageous Effect of the Present Disclosure

According to the superconducting wire and the superconducting coil in accordance with the present disclosure, occurrence of a quench can be suppressed.

### Description of Embodiments of the Present Disclosure

First, embodiments of the present disclosure will be described in list form.

(1) A superconducting wire in accordance with one aspect of the present disclosure has a tape-like shape, and includes a superconducting layer. An amount of heat required to raise temperature from 77 K to 300 K, for a unit region having a length of 1 m and a width of 4 mm in the superconducting wire, is more than or equal to 200 J and less than or equal to 500 J.

With such a configuration, since the amount of heat required to raise the temperature from 77 K to 300 K in the unit region of the superconducting wire has a relatively large value, even when the superconducting wire has a local flaw, for example, and an electric resistance value is increased at the portion of the flaw and heat is generated, an increase in the temperature of the superconducting wire can be suppressed to some extent. This can suppress a sudden increase in the temperature of the superconducting wire due to generation of the heat, and can eventually suppress occurrence of a quench and occurrence of a failure such as a burnout of the superconducting wire. It should be noted that the unit region described above is intended to define the amount of heat described above. The superconducting wire in accordance with one aspect of the present disclosure may have a length of less than 1 m or a width of less than 4 mm.

(2) The superconducting wire has a mean thermal conductivity at a temperature of 77 K of more than or equal to 100 W/(m·K).

In this case, even when the electric resistance value is locally increased due to a flaw or the like and heat is generated as described above, the heat can be immediately diffused to other portions of the superconducting wire. This can suppress a local temperature increase in the superconducting wire. It should be noted that, for example when the superconducting wire has a stacked structure composed of a plurality of components, the mean thermal conductivity used herein can be defined by calculating the product of the thermal conductivity and the thickness of each component, adding the products of the respective components, and dividing the result by the thickness of the entire superconducting wire.

(3) The superconducting wire includes a substrate layer, the superconducting layer, and a coating layer. The substrate layer has a first surface and a second surface opposite to the first surface. The superconducting layer has a third surface and a fourth surface opposite to the third surface. The superconducting layer is disposed on the substrate layer such that the third surface faces the second surface. The coating layer is disposed on the first surface and on the fourth surface. The coating layer includes a conductor layer.

In this case, the amount of heat and the mean thermal conductivity can be adjusted by adjusting the materials and the thicknesses of the substrate layer and the coating layer of the superconducting wire.

(4) A superconducting coil in accordance with one aspect of the present disclosure includes the superconducting wire described above and an insulator. The superconducting wire is wound to have a spiral shape with a space being interposed between windings of the superconducting wire. The space is filled with the insulator.

Thereby, a reliable superconducting coil can be achieved by using the superconducting wire in which occurrence of a quench is suppressed.

### DETAILS OF EMBODIMENTS OF THE PRESENT DISCLOSURE

Next, details of the embodiments will be described. It should be noted that identical or corresponding parts in the drawings below will be designated by the same reference numerals, and the description thereof will not be repeated. Further, at least parts of the embodiments described below may be arbitrarily combined.

### First Embodiment

(Configuration of Superconducting Wire)

FIG. 1 is a schematic cross sectional view of a superconducting wire 100 in accordance with the present embodiment. FIG. 1 shows a cross section of the superconducting wire with a tape-like shape, in a direction perpendicular to a longitudinal direction of the superconducting wire. As shown in FIG. 1, superconducting wire 100 in accordance with the present embodiment has a substrate layer 1, a superconducting layer 2, and a coating layer 3 as a coating conductor layer.

Substrate layer 1 preferably has a tape-like shape having a thickness smaller than a length thereof in the longitudinal direction. Substrate layer 1 has a first surface 1a and a second surface 1b. Second surface 1b is a surface opposite to first surface 1a. Substrate layer 1 may be constituted of a plurality of layers. More specifically, substrate layer 1 may include a substrate 11 and an intermediate layer 12. Substrate 11 is located at the first surface 1a side, and intermediate layer 12 is located at the second surface 1b side.

Substrate 11 may be constituted of a plurality of layers. For example, substrate 11 is constituted of a first layer 11a, a second layer 11b, and a third layer 11c. For example, stainless steel is used for first layer 11a. For example, copper (Cu) is used for second layer 11b. For example, nickel (Ni) is used for third layer 11c.

Intermediate layer 12 is a layer serving as a buffer for forming superconducting layer 2 on substrate 11. Intermediate layer 12 preferably has a uniform crystal orientation. Moreover, for intermediate layer 12, a material having a small lattice constant mismatch with respect to a material for superconducting layer 2 is used. More specifically, for intermediate layer 12, cerium oxide (CeO₂) or yttria stabilized zirconia (YSZ) is used, for example.

Superconducting layer 2 is a layer containing a superconductor. The material used for superconducting layer 2 is a rare-earth-based oxide superconductor, for example. For example, the rare-earth-based oxide superconductor used for superconducting layer 2 is REBCO (REBa₂Cu₃O_{y}, where RE represents a rare earth such as yttrium (Y), neodymium (Nd), samarium (Sm), europium (Eu), gadolinium (Gd), holmium (Ho), or ytterbium (Yb)).

Superconducting layer 2 has a third surface 2a and a fourth surface 2b. Fourth surface 2b is a surface opposite to third surface 2a. Superconducting layer 2 is disposed on substrate layer 1. More specifically, superconducting layer 2 is disposed on substrate layer 1 such that third surface 2a faces second surface 1b. Substrate layer 1 and superconducting layer 2 constitute a wire portion 10.

Coating layer 3 is a layer which coats substrate layer 1 and superconducting layer 2. Coating layer 3 is disposed on first surface 1a of substrate layer 1 and fourth surface 2b of superconducting layer 2. In addition, from another viewpoint, coating layer 3 is formed to cover the outer periphery of substrate layer 1 and superconducting layer 2.

Coating layer 3 includes a stabilization layer 31 as a first conductor layer formed on superconducting layer 2 and first surface 1a of substrate layer 1, and a protective layer 32 as a second conductor layer formed on stabilization layer 31. Stabilization layer 31 is formed on fourth surface 2b of superconducting layer 2, on first surface 1a of substrate layer 1, and on side surfaces of superconducting layer 2 and substrate layer 1. That is, stabilization layer 31 is formed to cover the outer periphery of wire portion 10. Stabilization layer 31 protects superconducting layer 2, dissipates locally generated heat in superconducting layer 2, and functions as a conductor for bypassing a current upon occurrence of a quench (a phenomenon in which transition is made from a superconducting state to a normal conducting state) in superconducting layer 2. In addition, when protective layer 32 is formed using a plating method, for example, stabilization layer 31 also has a function of protecting superconducting layer 2 from a plating solution used for the plating method. A material used for stabilization layer 31 is silver (Ag), for example.

Stabilization layer 31 may have a single-layer structure, or may have a multilayer structure. In addition, stabilization layer 31 can adopt any configuration as long as its adhesion with superconducting layer 2 and first surface 1a of substrate 11 can be improved. Stabilization layer 31 may include a layer formed by an evaporation method or a sputtering method, or may include a layer formed by a plating method.

Adhesion between stabilization layer 31 and superconducting layer 2 or adhesion between stabilization layer 31 and substrate 11 may be improved, for example, by forming a layer made of silver as stabilization layer 31 and thereafter performing heat treatment.

Protective layer 32 is formed on stabilization layer 31. Protective layer 32 protects stabilization layer 31 and wire portion 10. Further, protective layer 32 can also function as a conductor for bypassing a current upon occurrence of a quench in superconducting layer 2. Protective layer 32 is formed to cover at least a part of the outer periphery of the wire portion composed of substrate layer 1 and superconducting layer 2, with stabilization layer 31 being interposed therebetween. In FIG. 1, protective layer 32 is formed to cover the entire outer periphery of the wire portion.

In superconducting wire 100 shown in FIG. 1, for a unit region having a length of 1 m and a width of 4 mm, an amount of heat required to raise temperature from 77 K to 300 K is more than or equal to 200 J and less than or equal to 500 J. A method for measuring the amount of heat will be described later.

In addition, superconducting wire 100 has a mean thermal conductivity at a temperature of 77 K of more than or equal to 100 W/(m·K). The mean thermal conductivity can be calculated from the thermal conductivities of the material layers constituting superconducting wire 100 at a temperature of 77 K, and the thicknesses of the respective material layers.

The amount of heat and the mean thermal conductivity as described above can be achieved, for example, by adjusting the configuration of substrate 11 and the configuration of coating layer 3.

(Method for Measuring Amount of Heat)

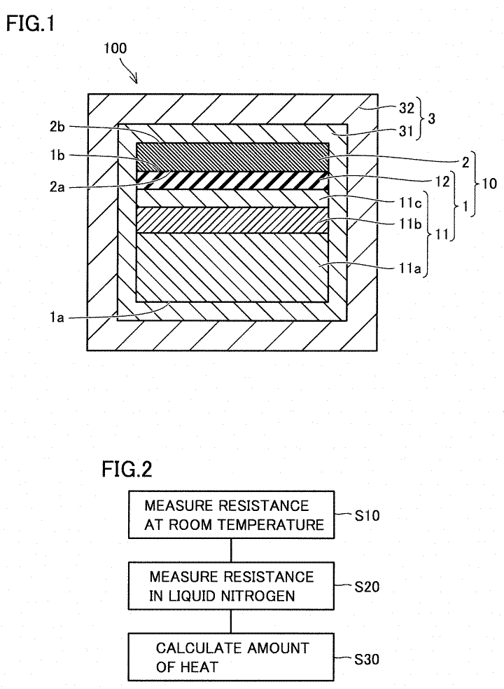

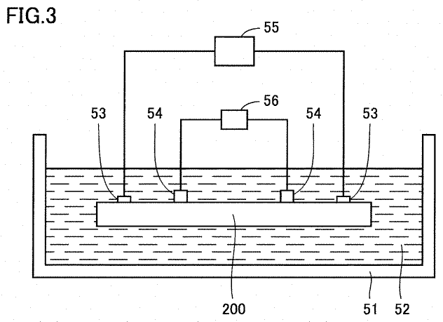

FIG. 2 is a process chart for illustrating a method for measuring the amount of heat required to raise the temperature from 77 K to 300 K for the unit region in superconducting wire 100. FIG. 3 is a schematic view for illustrating the method for measuring the amount of heat required to raise the temperature from 77 K to 300 K for the unit region in superconducting wire 100. The method for measuring the amount of heat in the superconducting wire will be described using FIGS. 2 and 3.

In the method for measuring the amount of heat in superconducting wire 100, first, a step of measuring a resistance at room temperature (S10) is performed, as shown in FIG. 2. In this step (S10), a method similar to the four-terminal method commonly used to measure a resistance can be used. Specifically, as shown in FIG. 3, a sample 200 of the superconducting wire cut to have a length of 150 mm, for example, is prepared, and current terminals 53 are soldered to both ends of sample 200. In addition, voltage terminals 54 are soldered to a central portion of the sample, with a spacing between the terminals of 100 mm, for example. Current terminals 53 are connected to a current measurement unit 55. Voltage terminals 54 are connected to a voltage measurement unit 56. Then, for sample 200 having the terminals connected as described above, a resistance value at the room temperature (300 K) is measured.

Subsequently, a step of measuring a resistance in liquid nitrogen (S20) is performed. Specifically, sample 200 having current terminals 53 and voltage terminals 54 connected as described above is immersed in liquid nitrogen 52 held within a container 51 as shown in FIG. 3, and is cooled. A resistance value between voltage terminals 54 is measured by measuring a voltage value between voltage terminals 54 with a current sufficiently higher than a critical current value (Ic) of the sample wire being applied to sample 200 cooled to 77 K, which is the temperature of liquid nitrogen 52. On this occasion, the current to be applied can have a value which is about three times the critical current value, for example. Then, when the measured resistance value becomes equal to the resistance value at the room temperature, application of the current is stopped. It should be noted that, at the time point when application of the current is stopped, the temperature of the sample is considered to be equal to the room temperature, which is the temperature condition for the measurement in the step (S10).

In this step (S20), a time from when application of the current is started to when it is stopped, and changes in the voltage value and the current value during the time from when application of the current is started to when it is stopped are measured. Here, if a time taken until the resistance value becomes equal to the value at the room temperature is longer than 50 milliseconds, the value of the current to be applied to sample 200 is increased to cause the resistance value to increase to the resistance value at the room temperature in a shorter time. For example, the value of the current may be determined such that the time taken until the resistance value increases to the resistance value at the room temperature is several milliseconds to about 20 milliseconds. The reason why the time described above is set to be short is that, if the time is several milliseconds to about 20 milliseconds as described above, a cooling amount, which is an amount of heat removed from sample 200 by liquid nitrogen 52 per unit time and unit area, can be considered to be equal to a critical heat flux q_{c} of the liquid nitrogen.

Subsequently, a step of calculating the amount of heat (S30) is performed. In this step (S30), specifically, the amount of heat is calculated as described below.

Data determined in the above step (S20), that is, the temporal change in current, the change in voltage between voltage terminals 54, and the time from when application of the current is started to when it is stopped, in a temperature raising process from when application of the current is started to when it is stopped, are defined as I(t), V(t), and t_{300K}, respectively. Using these parameters, an amount of heat Q supplied to sample 200 in the temperature raising process is expressed by the following equation (1).

[Equation 1]

Q=∫₀^{t}^{_{300K}}I(t)V(t)dt (1)

In addition, an amount of heat Q_{cool} cooled by the liquid nitrogen in the temperature raising process is expressed by the following equation (2), where S represents a surface area (between voltage terminals 54) of sample 200.

[Equation 2]

Q_{cool}=q_{c}×t_{300K}×S (2)

Based on these equations, an amount of heat Q₇₇₋₃₀₀ required to raise the temperature from 77 K to 300 K in a unit region of sample 200 is expressed by the following equation (3), where L represents a spacing between the voltage terminals (unit: m), and W represents a wire width (unit: mm). It should be noted that the unit region is a region having a length of 1 m and a width of 4 mm in sample 200.

$$\begin{matrix}[ Equation 3 ] & \\ {Q}_{77 \text{-} 300} = ( Q - {Q}_{cool} ) / ( \frac{L}{1 [ m ]} \times \frac{W}{4 [ mm ]} ) & ( 3 )\end{matrix}$$

(Method for Manufacturing Superconducting Wire)

A method for manufacturing superconducting wire 100 in accordance with the present embodiment will be described below. Any method can be used as the method for manufacturing superconducting wire 100. For example, the method for manufacturing superconducting wire 100 includes a substrate preparation step (S100), an intermediate layer formation step (S200), a superconducting layer formation step (S300), and a coating layer formation step (S400).

The step (S100) is a step of preparing substrate 11. In the step of preparing substrate 11, substrate 11 is formed using any conventionally known method. For example, first layer 11a constituted of a tape made of a metal such as stainless steel is prepared, and second layer 11b and third layer 11c are formed in order on first layer 11a. As a method for forming these layers, any method such as a plating method or a sputtering method can be used.

The step (S200) is a step of forming the intermediate layer. In this step (S200), intermediate layer 12 is formed on third layer 11c of substrate 11. As a method for forming intermediate layer 12, any method such as a plating method or a sputtering method can be used. Thereby, substrate layer 1 composed of substrate 11 and intermediate layer 12 is obtained.

In the step (S300), superconducting layer 2 is formed on intermediate layer 12. In this step (S300), superconducting layer 2 is formed using any conventionally known method. Thereby, wire portion 10 is obtained.

The step (S400) is a step of forming coating layer 3 as a coating conductor layer, and includes a step of forming stabilization layer 31 and a step of forming protective layer 32. In the step of forming stabilization layer 31, stabilization layer 31 as the first conductor layer is formed at least on fourth surface 2b of superconducting layer 2 and on first surface 1a of substrate layer 1. In the step of forming stabilization layer 31, stabilization layer 31 may be formed to cover the entire side surfaces of wire portion 10. As a method for forming stabilization layer 31, any method such as a sputtering method or a plating method can be used.

As the step of forming protective layer 32, the protective layer may be formed on stabilization layer 31 using a plating method, for example. As a method for forming protective layer 32, any method may be used instead of the plating method described above. Thereby, the superconducting wire shown in FIG. 1 can be obtained.

(Function and Effect of Superconducting Wire)

According to the superconducting wire in accordance with the present embodiment, amount of heat Q₇₇₋₃₀₀ required to raise the temperature from 77 K to 300 K in the unit region of superconducting wire 100 has a relatively large value. Thus, even when superconducting wire 100 has a local flaw, for example, and an electric resistance value is increased at the portion of the flaw, an increase in the temperature of superconducting wire 100 due to heat at the portion of the flaw can be suppressed to some extent. This can suppress a sudden increase in the temperature of superconducting wire 100 due to generation of the heat, and can eventually suppress occurrence of a failure such as a burnout of superconducting wire 100.

In addition, superconducting wire 100 has a mean thermal conductivity at a temperature of 77 K of more than or equal to 100 W/(m·K). Thus, even when the electric resistance value of superconducting wire 100 is locally increased due to a flaw or the like and heat is generated, the heat can be immediately diffused to other portions of superconducting wire 100. This can suppress a local temperature increase in superconducting wire 100.

As shown in FIG. 1, superconducting wire 100 includes substrate layer 1, superconducting layer 2, and coating layer 3. Substrate layer 1 has first surface 1a and second surface 1b opposite to first surface 1a. Superconducting layer 2 has third surface 2a and fourth surface 2b opposite to third surface 2a. Superconducting layer 2 is disposed on substrate layer 1 such that third surface 2a faces second surface 1b. Coating layer 3 is disposed on first surface 1a and on fourth surface 2b. In this case, amount of heat Q₇₇₋₃₀₀ and the mean thermal conductivity can be adjusted by adjusting the materials and the thicknesses of substrate layer 1 and coating layer 3 of superconducting wire 100.

### Second Embodiment

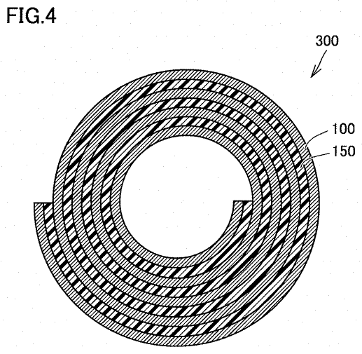

A configuration of a superconducting coil 300 in accordance with the present embodiment will be described below with reference to the drawing. FIG. 4 is a cross sectional view of superconducting coil 300 in accordance with the present embodiment in a cross section perpendicular to a coil axis thereof. As shown in FIG. 4, superconducting coil 300 in accordance with the present embodiment has superconducting wire 100 and an insulator 150.

Superconducting wire 100 is superconducting wire 100 described above in the first embodiment, and has a spiral shape centering on the coil axis. That is, superconducting wire 100 is wound about the coil axis. Superconducting wire 100 is wound with a space being interposed between windings of superconducting wire 100.

The space between the windings of superconducting wire 100 is filled with insulator 150. Thereby, the windings of superconducting wire 100 are insulated from each other and are fixed relative to each other. From another viewpoint, superconducting wire 100 is sandwiched by insulator 150.

For example, a thermosetting resin is used for insulator 150. The thermosetting resin used for insulator 150 preferably has a low viscosity to such an extent that the thermosetting resin in a state before being set can be introduced into the space between the windings of superconducting wire 100. The thermosetting resin used for insulator 150 is an epoxy resin, for example.

(Method for Manufacturing Superconducting Coil)

Any method can be adopted as a method for manufacturing superconducting coil 300. For example, superconducting wire 100 is wound about the coil axis, and then a resin to be insulator 150 is introduced into the space between the windings of superconducting wire 100. Thereafter, resin-setting treatment is performed. As the setting treatment, heat treatment is performed, for example. It should be noted that electrode terminals and the like not shown may be connected to superconducting wire 100. Thereby, superconducting coil 300 shown in FIG. 4 is obtained.

(Function and Effect of Superconducting Coil)

In superconducting coil 300 shown in FIG. 4, reliable superconducting coil 300 can be achieved by using superconducting wire 100 in which occurrence of a quench is suppressed.

### Example

In order to confirm the effect of the present invention, experiments as described below were conducted.

<Samples>

Samples of Example:

As samples of an example, superconducting wires in which amounts of heat required to raise temperature from 77 K to 300 K, for a unit region having a length of 1 m and a width of 4 mm, were 200 J, 300 J, 400 J, and 500 J, respectively, were used.

Samples of Comparative Example:

As samples of a comparative example, superconducting wires in which amounts of heat required to raise temperature from 77 K to 300 K, for a unit region having a length of 1 m and a width of 4 mm, were 150 J and 550 J, respectively, were used.

For each of the samples of the example and the comparative example described above, a test piece having a length of 150 min was cut out, and current terminals and voltage terminals for measurement by the four-terminal method were placed on the test piece, as in the case of measuring the amount of heat in the first embodiment. Ten test pieces were prepared for each of the samples of the example and the comparative example.

<Experiments>

Experiment 1:

Each of the samples of the example and the comparative example was cooled to a liquid nitrogen temperature, a current corresponding to a critical current value was passed therethrough, and it was confirmed that no quench occurred.

Experiment 2:

For each of the samples of the example and the comparative example for which it was confirmed in experiment 1 described above that no quench occurred, an imitation flaw was formed on a surface of the superconducting wire, in a central portion between the voltage terminals. Specifically, a flaw reaching to the superconducting layer was formed with a scriber to have a plane size of 0.1 mm in a longitudinal direction of the superconducting wire and 2 mm in a width direction thereof.

Then, the test piece with the flaw was cooled again to the liquid nitrogen temperature, the current corresponding to the critical current value was passed therethrough, and it was confirmed whether or not a quench occurred.

<Result>

Regarding the samples of the example, no quench occurred in all the samples also in experiment 2, and damage to the samples and the like did not occur. In contrast, regarding the samples of the comparative example, a quench occurred in all the samples, and the samples were burnt out near the flaw.

Although the embodiments and the example of the present invention have been described above, it is also possible to variously modify the embodiments described above. In addition, the scope of the present invention is not limited to the embodiments described above. The scope of the present invention is defined by the scope of the claims, and is intended to include any modifications within the scope and meaning equivalent to the scope of the claims.

### REFERENCE SIGNS LIST

1: substrate layer; 1a: first surface; 1b: second surface; 2: superconducting layer; 2a: third surface; 2b: fourth surface; 3: coating layer; 10: wire portion; 11: substrate; 11a: first layer; 11b: second layer; 11c: third layer; 12: intermediate layer; 31: stabilization layer; 32: protective layer; 51: container; 52: liquid nitrogen; 53: current terminal; 54: voltage terminal; 55: current measurement unit; 56: voltage measurement unit; 100: superconducting wire; 150: insulator; 200: sample; 300: superconducting coil.

1. A superconducting wire with a tape-like shape, comprising a superconducting layer, wherein
an amount of heat required to raise temperature from 77 K to 300 K, for a unit region having a length of 1 m and a width of 4 mm in the superconducting wire, is more than or equal to 200 J and less than or equal to 500 J.

2. The superconducting wire according to claim 1, wherein the superconducting wire has a mean thermal conductivity at a temperature of 77 K of more than or equal to 100 W/(m·K).

3. The superconducting wire according to claim 1, wherein
the superconducting wire comprises a substrate layer having a first surface and a second surface opposite to the first surface,
the superconducting layer has a third surface and a fourth surface opposite to the third surface, and is disposed on the substrate layer such that the third surface faces the second surface, and
the superconducting wire further comprises a coating layer disposed on the first surface and on the fourth surface.

4. A superconducting coil comprising:
the superconducting wire according to claim 1; and
an insulator, wherein
the superconducting wire is wound to have a spiral shape with a space being interposed between windings of the superconducting wire, and
the space is filled with the insulator.
